(19) United States
(12) Patent Application Publication
(10) Pub. No.: US 2004/0151964 A1
(43) Pub. Date: Aug. 5, 2004

(54) Fuel cell air supply

(76) Inventors: Helmut Finger, Leinfelden-Echterdingen (DE); Peter Fledersbacher, Stuttgart (DE); Gerhard Konrad, Ulm (DE); Manfred Stute, Esslingen (DE); Paul Loeffler, Stuttgart (DE); Siegfried Sumser, Stuttgart (DE)

Correspondence Address: Davidson Davidson & Kappel, 14th Floor, 485 Seventh Avenue, New York, NY, 10018, US

(21) Appl. No.: 10/475,415

(22) PCT Filed: Apr. 11, 2002
(86) PCT No.: PCT/EP02/04023

(30) Foreign Application Priority Data
Apr. 22, 2001 (DE) 10120947.9

(51) Int. Cl. H01M 8/04; F04B 23/14

(52) U.S. Cl. 429/34; 429/22; 417/85

(57) ABSTRACT

A fastening device for a convertible top according to the invention comprises a front bow; a front window frame; a bracket, which is arranged on one of the group of the front bow and the front window frame; a first catch element, which is assigned to the respectively other component of the group of the front bow and the front window frame, said first catch element being secured in a movable manner and being connectable to said bracket, it being possible for the first catch element to be pivoted about a first axis; and at least one second catch element, which can be connected to said bracket; wherein the second catch element can be pivoted about a second axis, said second axis being spaced apart from said first axis.

The invention relates to an apparatus with method procedures for control purposes, mainly as claimed in claims 1, 2 and 4 as well as 9 to 12, for an air supply system for fuel cells.

In comparison to conventional fuel cell air supply systems which are equipped with relatively low-speed positive-displacement compressors, two-stage compression of the air by means of pure, very high-speed continuous-flow compressors is proposed according to the invention.

In this case, it is worthwhile using continuous-flow machines which produce a centrifugal field for design overall pressure ratios of more than 3, such as that which radio compressors can produce, in order to produce high specific amounts of work per unit volume.

If the fuel cell is intended to be used for vehicle propulsion, the high specific power levels with respect to the physical space are of dominant importance just for reasons relating to the shortage of space.

If the analogy of the development trends over time relating to internal combustion engines is used, then it can be seen that the turbocharger motors for turbocharged engines can be replaced completely item by item, leading to the expectation that low-pressure fuel cells for vehicle traction, which can be represented relatively simply, will also be replaced over the course of future development phases by fuel cells with higher inlet pressures, in order to accommodate the desired high power levels in the small physical volumes.

In comparison to positive-displacement compressors with a high degree of pressure pulsations, not only do the very wide rotation speed differences with continuous-flow compressors in the direction of high values result in physical space advantages, but the continuous flow through the continuous-flow machines also results in very good conditions for low-noise and particularly high-efficiency operation.

Since the hydrogen consumption of fuel cells has equivalent importance for efficient evaluation of the propulsion performance as the fuel consumption of internal combustion engines, the optimization of the fuel cell air supply system is regarded as being just as highly important as the optimization of the load cycle efficiency of piston engines. The air supply system can represent up to a good third of the contribution to the overall system efficiency of fuel cells.

As is evident from European Patent Application EP 1 009 053 A1, where two-stage charging of the fuel cell is likewise envisaged, this, however, disadvantageously makes use of a positive-displacement charger which is driven by an electric motor. The effect in terms of noise and the loss of efficiency has obviously not been considered.

Furthermore, this application does not mention intercooling, which improves the system efficiency, even though this easily allows the efficiency of the air supply system to be increased by orders of magnitude of up to 20%.

The information relating to exhaust via a so-called overpressure valve after the high-pressure stage gives cause to believe that the formulated prior art should be regarded as a coarse initial stage. The positive effect of controllable circulation which influences the efficiency and the critical importance of this controllable element for stable operation of the fuel cell, in which this prevents the risk of compressor pumping when the flow rates are reduced, has actually not been identified.

The object of producing a space-saving, low-noise, high-efficiency fuel cell air supply system which can be operated in a stable manner over wide flow rate ranges is in principle made possible by the implementation of the apparatus by means of claims 1, 2, 3 and 4 as a starting point. However, the critical factor for successful operation of the apparatus is the implementation of method claims 9 to 12, which characterize the advantageous control of the power supply to the electric motor, the control of the circulation valve and, equally, the power supply and control of the variable elements in the area or in the turbine.

While claim 1 characterizes the basic circuit of the two continuous-flow compressors for a low-pressure compressor with an electrical drive and a high-pressure compressor with a turbine drive connected in series, claim 2 results in an extension to the system by means of a circulation apparatus, which can guarantee stable operation of the continuous-flow compressors and of the overall air supply system with a fuel cell.

The stipulation of the electrical drive for the low-pressure stage, which allows in the order of ⅔ of the overall power for the two compressor stages to be supplied, is justified on the basis of the better configuration of the low-pressure compressor with a larger rotor diameter, and hence the lower rotation speed requirements for the electric motor. This also includes the rotor channels in the low-pressure compressor, which can be designed better in terms of efficiency on the basis of these boundary conditions than in the high-pressure stage, where the low inlet pressure to the compressor also has an advantageous effect and, with the flows to the rotors that can be produced here, offers better characteristics in terms of pumping stability in the low mass flow area, and allows a wider range for the compressor family of characteristics. This would not be the case if the power were fed in via the electric motor in the high-pressure stage, assuming the same upper electric motor rotation speed.

The wheels in the freewheeling device have smaller diameters, simply for efficiency reasons (better channel profile, reduced gap losses) and in general have virtually no restrictions on their maximum rotation speeds, since functional bearings for turbochargers of the size of interest already cover, as standard, rotation speeds of up to 300 000 rpm.

In principle, the operating range of a continuous-flow compressor is limited by the pumping limit in the direction of low mass flow rates, and by the choking limit in terms of high mass flow rates.

The critical factor for the mass flow range for the fuel cell in terms of a continuous-flow compressor is the area of low flow rates, which in general lead to the pumping problems which have been mentioned. For this reason, the fuel cell is provided with a bypass line in parallel with the fuel cell and having a controllable valve. This allows the compressor mass flow to be increased even at very low fuel cell flow rates through the circulation mass flow, which is governed by the valve opening and the pressure ratio across the valve, and to be kept in the stable areas of the operating families of characteristics for the two compressors even at relatively high pressure ratios.

Claim 3 takes account of the possible ways to make major improvements to the system efficiency in a very simple manner by means of intercooling between the two compressor stages. Orders of magnitude of up to 20% can easily be achieved with high mass flow rates and pressures after the first stage. In comparison to the major amounts of development effort for improving the component efficiencies in the machines, this measure is extremely cost-effective, but must be paid for by a certain amount of physical space being required if the pressure losses are to remain insignificant.

Claim 4 describes variable flow cross sections around and in the turbine which can be controlled by the controller or control system via an adjusting element.

When we refer to variable flow cross sections around the turbine, these could be flaps or slide valves which are placed upstream of or else downstream from the turbine and essentially include a ram-pressure function. However, these have the disadvantage of the choking effect of the cross sections that are matched to the ram-air pressures, and this reduces the efficiency. The use of blow-out valves for the classification that is carried out here of the variable elements considered around and in the turbine, and which can likewise be connected via an actuator to the electronic controller or control system, should also not be excluded here.

However, only the variable flow cross sections within the turbine, to be precise best of all the input guide gratings which are generally arranged directly in front of the turbine rotor, in fact have an advantageous effect in terms of efficiency and thus in terms of energy recovery. Their narrowest channel cross sections are changed by rotary or translational movements of the guide vanes. This results not only in the narrowest flow cross-sectional area being changed, but also the inlet flow direction with respect to the turbine rotor, thus making it possible to significantly influence the efficiency of the turbine, the energy recovery and hence also the efficiency of the overall system. Variable turbines are of very major importance within the context of the method claims since they make it possible to control the desired process inlet pressures to the fuel cell in conjunction with the compressor stages accurately and advantageously in terms of efficiency.

Since the output product from the fuel cell is water vapor and air, it makes sense from the energy point of view to place the condenser downstream from the turbine, as can be seen from claim 5. The air and water are separated, and it is also possible to reuse the water.

It is just as feasible to use the water for the purpose of cooling components, such as the electric motors, as for the windscreen washing system. For special applications, for example for vehicles for use in desert areas, the water can also be supplied to a drinking water processing apparatus. For camping vehicles, the conditioned or unconditioned water could also be used for cooking or else for washing and/or toilet purposes. Irrespective of the use of the water that is produced, all of it or at least part of it can be stored in a tank before deciding on the purpose for which it will be reused.

In order to produce advantageous vacuum pressure for water extraction within the condenser, an appropriate diffuser could be used advantageously at the condenser outlet on the air side in conjunction with the water side. The risk of erosion on the turbine rotor by being hit by water, in particular in the rotor inlet area, can be counteracted by using wear-resistant materials for the rotors, or by using surface coatings. Since the temperature fluctuations in the turbine are not particularly high, the use of ceramics as a rotor material or coating material is not at all critical in this context of the susceptibility of ceramics to cracking.

One fundamental problem with regard to the air that is supplied to fuel cells is to keep the adjacent bearing lubricant areas of the compressors clean. Claims 6 and 7 relate to decoupling of the fuel cell air from the lubricant area for the bearings, in between which a buffer volume or separating area is arranged which is subject at least to the environmental pressure or even to an overpressure, thus making it possible to provide a barrier effect for the introduction of lubricant. In order to completely preclude the introduction of oil, application of pressure to the buffer volume results in a barrier air flow through the non-contacting bearing seals in the opposite direction to the direction in which lubricant could emerge into the bearing housing.

The problem of lubricant introduction into the fuel cell air no longer exists with the oil-free bearings according to claim 8. The developments of air bearings can, even more in the case of magnetic bearings, still involve a very high degree of development effort, however, which will not bear fruit until future fuel cell air supply systems.

Claim 9 is of particular importance for stable operation of the fuel cell from the air supply side. One characteristic feature of continuous-flow compressors is the instability limit that has already been mentioned and which occurs at low flow rates. In order to guarantee the required flow rate ranges for the fuel cell, the circulation device in the bypass is activated below a certain lower flow rate level, and the narrowest cross section of the valve is continuously variably matched, via the controller or control system, to the air required by the fuel cell. The flow rate point or compressor outlet pressure in the compressor family of characteristics can thus be kept close to the pumping limit with specific tolerances, by interaction with the metering of the electrical power supply to the low-pressure compressor drive, although the flow rate to the fuel cell decreases further in accordance with the demand. The closer the pumping limit is approached, the less is the amount of air that needs to be circulated, and the less is the reduction in efficiency in order to guarantee stable operation. In one refinement of the system, it may make sense to provide the compressors with a pump sensor system, which is coupled to the controller or control system, thus also further simplifying the consumption optimization of the cell.

Claim 10 relates to the variability of the flow cross sections downstream from the fuel cell output in conjunction with the desired process inlet pressure to the fuel cell. The variable narrowest flow cross section to the turbine is sensibly located directly in front of the turbine rotor, by means of a moving input guide grating, in order on the one hand to make it possible to produce the required ram-pressure effect for the air/vapor mixture flowing through it, and on the other hand to improve the efficiency of recovery of the energy which is supplied to the turbine, in order to drive the high-pressure compressor efficiently and thus to achieve savings in the amount of electrical energy which is fed to the low-pressure compressor.

Claim 11 relates to the control of the maximum possible expansion pressure ratio for the turbine. Against the background of this control claim, it is advantageously possible for the narrowest flow cross section of the overall system to be located in the predominant operating range of the fuel cell within the turbine. This means that the mass flow through the fuel cell is governed and is controlled to a major extent via the variable turbine in conjunction with the low-pressure power supply. This method feature of turbine cross-section control also addresses the circulation control philosophy in the area of the pumping limit from claim 9. Setting the maximum possible expansion pressure ratios across the turbine also results in a major reduction in the restriction in the circulation valve, particularly at the low flow rates, so that these cross sections can be controlled to be relatively large corresponding to the amount of circulation, with the losses thus remaining low.

The subject of starting the generation of electricity from the fuel cell is directly related to the starting of its air supply system, which is considered from the method side in claim 12. The main feature is that at least part of the power is supplied from the electrical energy store to the electric motor for the low-pressure compressor, which can thus start up the entire system. The freewheeling device is thus likewise set in motion via the energy that is converted to pressure energy upstream of the turbine, and via the subsequent expansion in the turbine. If a variable turbine is used, it may make sense to reduce the narrowest cross section of the turbine in the starting phase to low values, as a result of which the freewheeling device can profit to a major extent from the indirect aerodynamically coupled energy conversion by the low-pressure compressor, or electric motor. An initially wide opening of the circulation valve likewise ensures that the freewheeling device is rapidly included in the energy conversion chain, thus also resulting in major assistance to rapid starting of the freewheeling device with the guide grating for the turbine being virtually closed. These method steps relating to the interaction between the energy source, or the low-pressure compressor, the circulation device and the variable turbine is not just restricted to the starting phase, but is also repeated (in an analogous form for every load cycle in the cell) to a greater or lesser extent with regard to the relevant control elements for the control process for the components that have been mentioned. The most important time results of this control procedure during the starting or load-cycle phases are the rapid production of the optimum state data such as the pressure and temperature of the air which is flowing into the inlet of the fuel cell and, with this state, the chemical reaction between the hydrogen and the oxygen in the air in the fuel cell is optimally supported, thus also guaranteeing that the mechanical strength of the sensitive parts, for example the membrane, is not endangered.

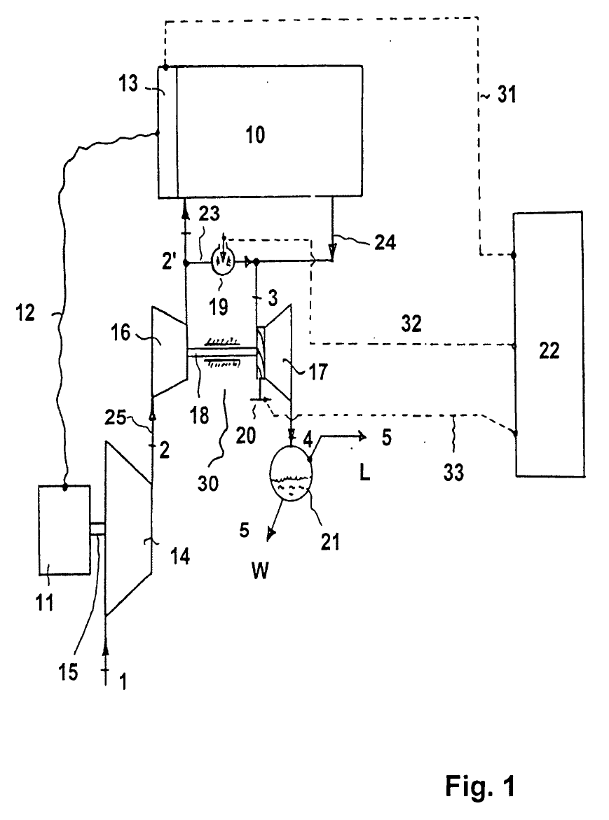

The majority of the features of the fuel cell air supply system can be seen from the outline circuit sketch in FIG. 1.

Filtered air is sucked in from the environment through the low-pressure compressor (14) in the state 1. The compressor rotor of the low-pressure compressor (14) is connected via a driveshaft (15) to the electric motor (11), which represents the major unit for feeding energy via the low-pressure compressor into the air flow and thus into the overall system for fuel cell air supply. The energy is either supplied directly from the fuel cell (10) or from the electrical energy store (13) via the cable (12). The total state point 2 downstream from the low-pressure compressor is effectively governed by this amount of energy that is fed to the electric motor.

One element which is not shown in the overview sketch is an intercooler, which is invariably used when the hydrogen consumption is intended to be optimized for low consumption levels. On the other hand, it may be necessary for the inlet temperature to the cell to remain below a value in order not to endanger the mechanical strength of the membrane. The intercooling assists the process of reducing the power consumption of the high-pressure compressor (16), since the power consumption is directly proportional to its inlet temperature. Cooling downstream from the high-pressure compressor (16) with the state point 2′ is regarded as less worthwhile with the conventional stage pressure ratios and may be considered only when intercooling is not possible for specific reasons or the pressure ratios are in fact intended to be very high and it is therefore necessary to provide temperature protection for the cell. The extent to which a cooling medium is supplied to a heat exchanger which is placed between the low-pressure and high-pressure compressors (14, 16) or downstream from the high-pressure compressor (16), said cooling medium originating from air and water as the media flowing from the condenser outlet, depends essentially on the energetic relationships between the cooling medium and the air to be cooled, the boundary conditions and the optimization objectives.

The branch from which the circulation channel (23) forms a connection to form the outlet channel (24) of the fuel cell and which is critical to the operation of the overall system is connected downstream from the high-pressure compressor (16) but still upstream of the inlet into the fuel cell (10). A controllable valve (19) is installed in the circulation channel, or in the fuel cell bypass, and is opened to a certain extent in the area of the pumping limit depending on the point in the compressor family of characteristics, in order that the mass flow through the compressor is greater than the air flow through the fuel cell. This prevents pumping of the compressors.

The air/vapor mixture in the outlet pipe system (24) and the bypass mass flow then lead to the state point 3 upstream of the turbine (17), which may also include variable elements which are addressed by means of a controller or control system (22) by means of an operating device (20).

The turbine (17) is responsible for efficient energy recovery and drives the high-pressure compressor (16) via the shaft. The risk of erosion caused by water droplets striking the inlet blade system of the turbine rotor may be counteracted by using wear-resistant materials.

As already mentioned, one important development task is to guarantee that the fuel cell air supply is free of oil, in which context not only further-developed sealing concepts for conventional bearings (18) but also bearings (18) in which no oil is used at all, such as air bearings or magnetic bearings, will be of interest in the future.

After the turbine (17), the air/water-vapor/water mixture experiences the reduced-temperature state point 4 upstream of the condenser (21).

In the condenser (21), the water components are separated from the air, and the various components then flow away through their own outlet openings from the condenser 5L and 5W into the downstream outlet pipe system of the air supply device. The outlet pipe system may contain elements which ensure that there is a vacuum pressure in the condenser, and which are responsible for further use of the condensate.

The core intelligence for use of the fuel cell air system resides in the regulator (22) which is intended to optimize the interaction between the three controllable components, the electric motor by means of the signals (31), the circulation valve (19) by means of the signals 32 and, if appropriate, the variable elements of the turbine (17) by means of the signals (33). As is normal for internal combustion engines, the regulator (22) in the case of fuel cells is also for this purpose generally provided with stored electronic data in order to produce the optimum setting, or combination of the relevant actuator positions, for the selected operating points.

### List of Reference Numerals in FIG. 1

1 Continuous-flow compressor with an electrical drive, inlet level

2 Continuous-flow compressor with an electrical drive, outlet level, intercooler, inlet level/continuous-flow compressor for the freewheeling device, inlet level

2′ Continuous-flow compressor for the freewheeling device, outlet level, fuel cell inlet level

3 Turbine inlet level (rigid turbine with or without a blow-out apparatus or variable turbine)

4 Turbine outlet level, if appropriate condenser inlet level

5L Condenser air outlet level

5W Condenser water outlet level

10 Fuel cell

11 Electric motor

12 Electrical line to the fuel cell, electrical energy store

13 Electrical energy store, rechargeable battery or capacitor

14 Continuous-flow compressor driven by an electric motor

15 Continuous-flow compressor rotor rear face, connecting part for the bearing

16 Continuous-flow compressor, freewheeling device

17 Turbine freewheeling device (rigid turbine with or without a blow-out apparatus or variable turbine)

18 Rotor bearing (ball bearing, journal bearing, air bearing, magnetic bearing)

19 Circulation valve downstream from the high-pressure compressor and upstream of the turbine inlet

20 Operation of the variable apparatus for the turbine

21 Condenser

22 Controller or control system for the air supply system

23 Connecting line downstream from the high-pressure compressor to upstream of the turbine inlet

24 Outlet pipe system of the fuel cell to the turbine

25 Outlet pipe system of the low-pressure compressor

30 Freewheeling device; continuous-flow compressor connected to the turbine via a rigid shaft

31 Signal for energy allocation from the fuel cell and/or electrical energy store for the electric motor

32 Signal for the closed/open position of the circulation valve actuator

33 Signal for the actuator for the variable element of the turbine

1. An apparatus for supplying air to fuel cells with compressors characterized
in that a continuous-flow compressor (14) is connected on the low-pressure side to an electric motor (11),
and in that a further high-pressure compressor (16), which is connected downstream in series and is in the form of a continuous-flow machine, is firmly coupled as a freewheeling device (30) to a turbine (17) and the turbine (17) is connected to the outlet pipe system (24) of the fuel cell (10).

2. The apparatus for supplying air to fuel cells as claimed in claim 1, characterized
in that, after the high-pressure compressor (16) and before the fuel cell (10), a connecting line (23) leads to the outlet pipe system (24) of the fuel cell (10), and a controllable valve (19) is introduced into this connecting line (23).

3. The apparatus for supplying air to fuel cells as claimed in claim 1, characterized
in that, after the low-pressure compressor (14), an intercooler is placed in the output pipe system (25) which leads to the high-pressure compressor.

4. The apparatus for supplying air to fuel cells as claimed in claim 1, characterized
in that elements which vary the flow cross sections are located in the area around the turbine (17) of the freewheeling device (30) or within the turbine (17), and can be coupled via the operating device (20) to a controller or control system.

5. The apparatus for supplying air to fuel cells as claimed in claim 1, characterized
in that a condenser (21) is arranged downstream from the turbine (17) and has an output for the water (W) and an output for the air (L), and in that apparatuses for producing vacuum pressure can be connected to the outputs (W, L).

6. A low-pressure compressor and electric motor as claimed in claim 1, characterized
in that there is a sealed separating area between the lubricant area for the bearing of the low-pressure compressor (14) and electric motor (11) and the compressor area of the air flow feed, and the separating area is subject at least to the environmental pressure or to an overpressure for the application of barrier air.

7. A high-pressure compressor and rotor bearing as claimed in claim 1, characterized
in that there is a separating area between the lubricant area for the bearing (18) of the freewheeling device (30) and the compressor area of the air flow feed for the high-pressure compressor (16), and the separating area is subject at least to the environmental pressure or to an overpressure for the application of barrier air.

8. A bearing, a low-pressure compressor, and a freewheeling device as claimed in claim 1,
characterized
in that, of the bearings of the low-pressure compressor or high-pressure compressor, at least the bearing (18) is designed to be oil-free in accordance with the features of an air bearing or magnetic bearing.

9. A method for controlling an apparatus as claimed in one of claims 1 and 2 for a fuel cell air supply,
characterized
in that the known nominal air mass flow of the fuel cell is adjusted in accordance with the signals (32) from the regulator (22) via the power supply to the electric motor (11) by means of the signals (31) in conjunction with the controlled adjustment of the closed/open positions of the circulation valve (19) or bypass flow of the fuel cell, and in this case also allow operating lines, or operating points in the compressor family of characteristics, very close to the instability limit (pumping limit) based on the sensitivity of the control system.

10. A method for controlling an apparatus as claimed in one of claims 1, 2 and 4 for a fuel cell air supply,
characterized
in that the variable narrowest cross section in the area around the turbine (17) or within the turbine (17) is varied in a controlled manner depending on the instantaneous mass flow and the turbine inlet temperature by means of the operating device (20) as a function of the control signal (33) such that the nominal inlet air pressure to the fuel cell (17) can be adjusted.

11. A method for controlling an apparatus as claimed in one of claims 1, 2 and 4 for a fuel cell air supply,
characterized
in that the variable narrowest cross section in the area around the turbine (17) or within the turbine (17) is varied in a controlled manner depending on the instantaneous mass flow and the turbine inlet temperature by means of the operating device (20) as a function of the control signal (33) such that the maximum possible expansion ratio across the turbine (17) can be adjusted.

12. A method for controlling an apparatus as claimed in one of claims 1, 2 and 4 for a fuel cell air supply,
characterized
in that the starting process or load-cycle process for the fuel cell air supply system is carried out at least partially via the electrical power supply from the electrical energy store (13) for the electric motor (11) and thus the power metering for the low-pressure compressor is carried out by means of the signals (31),
in the process, the settings for the closed/open positions of the circulation valve (19) or of the bypass mass flow for the fuel cell are implemented on the basis of the signals (32) from the regulator (22),
and, if necessary, the variable narrowest cross section in the starting or load-cycling state around or in the turbine (17) is influenced by means of the signals (33) from the regulator (22) such that
this results in the provision of the necessary process inlet pressures and process inlet temperatures in the fuel cell starting/load-cycle phase.
